(19) United States
(12) Patent Application Publication
(10) Pub. No.: US 2010/0328636 A1
(43) Pub. Date: Dec. 30, 2010

(54) Producing a Marker Pattern and Measurement of an Exposure-Related Property of an Exposure Apparatus

(75) Inventors: Johannes Anna Quaedackers, Veldhoven (NL); Paul Christiaan Hinnen, Veldhoven (NL); Eddy Cornelis Antonius Van Der Heijden, Netersel (NL); Michel Franciscus Johannes Van Rooy, Bladel (NL); Christian Marinus Leewis, Maastricht (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 12/817,315

(22) Filed: Jun. 17, 2010

Related U.S. Application Data
(60) Provisional application No. 61/220,244, filed on Jun. 25, 2009.

(51) Int. Cl. G03B 27/42; G01N 21/47

(52) U.S. Cl. 355/53; 356/446

(57) ABSTRACT

In order to determine whether an exposure apparatus is projecting patterns correctly, a marker pattern is used on a mask for printing a specific marker structure onto a substrate. This marker is then measured by an inspection apparatus to determine whether there are errors in exposure-related properties such as focus and dose. The projection of the marker pattern is modified so as to accentuate the production of side lobe-induced features of the marker structure relative to the production of side lobe-inducted features of the product structure. The form of the marker structure is more responsive to exposure variation than the form of the product structure to exposure variation. The marker pattern includes both primary features and secondary features that augment the side lobe arising from the primary feature to print side lobe-induced features on either side of a primary marker structure. Alternatively, the marker pattern is modified by having a different attenuation factor with respect to the product pattern. Alternatively, the marker pattern is modified by providing a marker dose different from the product dose.

### CROSS REFERENCE TO RELATED APPLICATIONS

This application claims the benefit under 35 U.S.C. 119(e) to U.S. Provisional Patent Appl. No. 61/220,244, filed Jun. 25, 2010, which is incorporated by reference herein in its entirety.

### BACKGROUND

1. Field of the Invention

The present invention relates to marker structures usable for measuring exposure—related properties of an exposure apparatus, for example, in the manufacture of devices by lithographic techniques. Specifically, the present invention relates to production of a marker structure on a substrate for measuring exposure-related properties of an exposure apparatus. The invention relates also to the patterning devices including the marker pattern, and to an exposure apparatus for projecting the marker pattern.

2. Related Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti parallel to this direction.

In order to monitor the lithographic process, it is necessary to measure parameters of the patterned substrate, for example the overlay error between successive layers formed in or on it. There are various techniques for making measurements of the microscopic structures formed in lithographic processes, including the use of scanning electron microscopes and various specialized tools. One form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle.

Scatterometers may be used to measure several different aspects of lithographic apparatuses, including their substrate orientation and exposure efficacy. Two important parameters of a lithographic apparatus and specifically of the exposure action that the lithographic apparatus carries out that may also be measured by scatterometers are focus and dose. Specifically, a lithographic apparatus has a radiation source and a projection system as mentioned below. The dose of radiation that is projected onto a substrate in order to expose it is controlled by various parts of the exposure apparatus (of the lithographic apparatus). It is mostly the projection system of the lithographic apparatus that is responsible for the focus of the radiation onto the correct portions of the substrate. It is important that the focusing occurs at the level of the substrate, rather than before or afterwards so that the sharpest image will occur at the level of the substrate and the sharpest pattern possible may be exposed thereon. This enables smaller product patterns to be printed.

The focus and dose of the radiation directly affect the parameters of the patterns or structures that are exposed on the substrate. Parameters that can be measured using a scatterometer are physical properties of structures that have been printed onto a substrate such as the critical dimension (CD) or sidewall angle (SWA) of, for example, a bar-shaped structure. The critical dimension is effectively the mean width of a structure such as a bar (or a space, dot or hole, depending on what the measured structures are). The sidewall angle is the angle between the surface of the substrate and the rising (or falling) portion of the structure.

In addition, mask shape corrections (focus corrections for correcting for the bending of a mask) can be applied if scribe lane structures are used with a product mask for focus measurements.

Focus and dose have been determined simultaneously by scatterometry (or scanning electron microscopy) from one-dimensional structures in the mask pattern (which gives rise to one-dimensional marker structures on the substrate, from which measurements are taken). A single structure can be used as long as that structure, when exposed and processed, has a unique combination of critical dimension and sidewall angle measurements for each point in a focus energy matrix (FEM). If these unique combinations of critical dimension and sidewall angle are available, the focus and dose values can be uniquely determined from these measurements.

Assist features may be used to improve focus/dose measurements. By assist features, it is meant that further structures are included in the pattern on the mask in order to compensate for edge of structure errors and blurring that can appear on printed patterns. An example of assist features would be a pair of narrow parallel bars on either side of a main single bar structure on a mask pattern. Although these assist features appear on the mask pattern, they do not appear in the printed marker structure on a substrate because they are too small to be distinguished by the wavelength used but are used for canceling out edge errors of the main structure. For example, the assist features may be configured to cause the slope of a CD against dose graph to be steeper than without the assist features, thus improving the responsivity of the CD measurement with respect to dose.

However, despite such improvements, the effect of focus/dose variation on a measured scatterometry response, such as variation in a pupil plane image, is still too low relative to disturbing factors for methods such as principle component (PC) analysis on scatterometry of focus/dose marks to be successful. For example there may be cross talk between the principle components that describe (a) the disturbing factor of bottom anti-reflective coating (BARC) thickness variation and (b) the principle component that describes imposed focus/dose variation.

### SUMMARY

Therefore, what is needed is a system and method to increase an effect of exposure variations on marker structures to increase sensitivity and responsivity of measurements of exposure-related properties such as focus and dose.

According to an embodiment of the present invention, there is provided a method of measuring an exposure-related property of an exposure apparatus used for producing a product structure on a substrate by projecting a product pattern from a patterning device onto the substrate, the method comprising the following steps. Producing a marker structure on a substrate using the exposure apparatus to be measured by projecting a marker pattern from a patterning device onto the substrate with a marker dose of radiation. Measuring a property of the marker structure to determine the exposure-related property of the exposure apparatus, wherein for the production of the marker structure. In one example, the step of projecting the marker pattern is modified so as to accentuate the production of side lobe-induced features of the marker structure relative to production of side lobe-induced features of the product structure by the projecting of the product pattern.

In one example, the radiation incident on the substrate during the projecting of the product pattern includes features of the product pattern and product side lobes arising in the projecting of the product pattern and the radiation incident on the substrate during the projecting of the marker pattern includes features of the marker pattern and marker side lobes arising in the projecting of the marker pattern.

In one example, the modification of the step of projecting the marker pattern accentuates the marker side lobes relative to the product side lobes for a given focus condition, such that, through the production of the side lobe-induced features of the marker structure, the form of the marker structure is more responsive to exposure variation (such as variation of focus, dose, astigmatism and/or lens aberration) than the form of the product structure to exposure variation.

According to another embodiment of the present invention, there is provided a patterning device for use in an exposure apparatus, the patterning device including a marker pattern for producing a marker structure on a substrate using the exposure apparatus by projecting the marker pattern from the patterning device onto the substrate, the marker pattern comprising: a first marker pattern feature configured to produce a marker structure feature on the substrate; and a second marker pattern feature configured to augment a marker side lobe arising from the first marker pattern feature to produce a side lobe-induced feature on the substrate beside the marker structure feature.

According to a further embodiment of the present invention, there is provided a patterning device for use in an exposure apparatus, the patterning device including a marker pattern for producing a marker structure on a substrate using the exposure apparatus by projecting the marker pattern from the patterning device onto the substrate, the marker pattern comprising a marker attenuating phase shifter; and a product pattern for producing a product structure on a substrate using the exposure apparatus by projecting the product pattern from the patterning device onto the substrate, the product pattern comprising a product attenuating phase shifter, wherein the marker attenuating phase shifter has a different attenuation factor with respect to the product attenuating phase shifter, the different attenuation factor selected so as to accentuate the production of side lobe-induced features of the marker structure relative to production of side lobe-induced features of the product structure by the projecting of the product pattern.

According to a still further embodiment of the present invention, there is provided an exposure apparatus for producing a product structure and a marker structure on a substrate, the exposure apparatus configured to project a product pattern from a patterning device onto the substrate with a product dose of radiation for production of the product structure, and to project a marker pattern from a patterning device onto the substrate with a marker dose of radiation for production of the marker structure, wherein the exposure apparatus provides a marker dose different from the product dose, the different dose factor selected so as to accentuate the production of side lobe-induced features of the marker structure by the projection of the market pattern relative to production of side lobe-induced features of the product structure by the projection of the product pattern.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a lithographic apparatus.

FIG. 2 depicts a lithographic cell or cluster.

FIG. 3 depicts a first scatterometer.

FIG. 4 depicts a second scatterometer.

FIG. 5 depicts a focus and dose measurement pattern.

FIG. 6a depicts a marker pattern, according to one embodiment of the present invention.

FIG. 6b depicts a graph of simulated relative intensity of exposure arising from illumination of the marker pattern shown in FIG. 6a.

FIG. 6c depicts simulated resist profiles of a marker structure arising from the exposure of the marker pattern shown in FIG. 6a for different focus offsets.

FIG. 7 depicts simulated resist profiles of a grating marker structure at a range of focus offsets.

FIG. 8a depicts graphs of critical dimension (CD) in nanometers verses focus offset for the primary bar feature and side lobe-induced feature of the printed marker.

FIG. 8b depicts simulated resist profiles for a wider range of focus offsets, including the offsets shown in FIG. 8a.

FIG. 9a depicts a marker pattern used in another embodiment of the present invention.

FIG. 9b depicts a graph of simulated relative intensity of exposure arising from illumination of the marker pattern shown in FIG. 9a.

FIG. 10a depicts a marker pattern used in another embodiment of the present invention.

FIG. 10b depicts a graph of simulated relative intensity of exposure arising from illumination of the marker pattern shown in FIG. 10a.

FIG. 11 depicts simulated resist profiles and corresponding transverse magnetic and transverse electric scatterometry pupil plane images.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

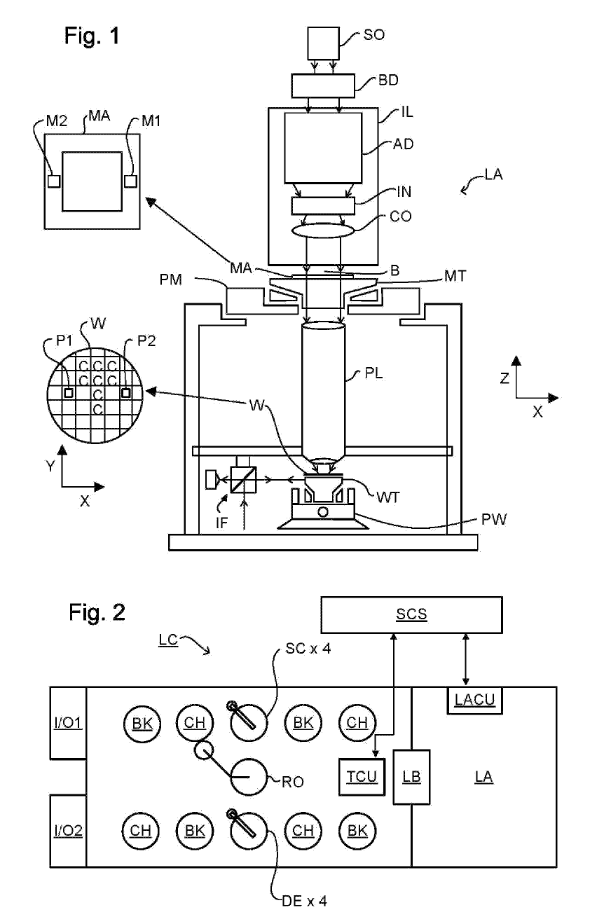

FIG. 1 schematically depicts a lithographic apparatus. The apparatus comprises:

an illumination system (illuminator) IL configured to condition a radiation beam B (e.g., UV radiation or DUV radiation), a support structure (e.g., a mask table) MT constructed to support a patterning device (e.g., a mask) MA and connected to a first positioner PM configured to accurately position the patterning device in accordance with certain parameters; a substrate table (e.g., a wafer table) WT constructed to hold a substrate (e.g., a resist coated wafer) W and connected to a second positioner PW configured to accurately position the substrate in accordance with certain parameters; and a projection system (e.g., a refractive projection lens system) PL configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g., an interferometric device, linear encoder, 2-D encoder or capacitive sensor), the substrate table WT can be moved accurately, e.g., so as to position different target portions C in the path of the radiation beam B. Similarly, the first positioner PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 2, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded, thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. However, the latent image in the resist has a very low contrast—there is only a very small difference in refractive index between the parts of the resist which have been exposed to radiation and those which have not—and not all inspection apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

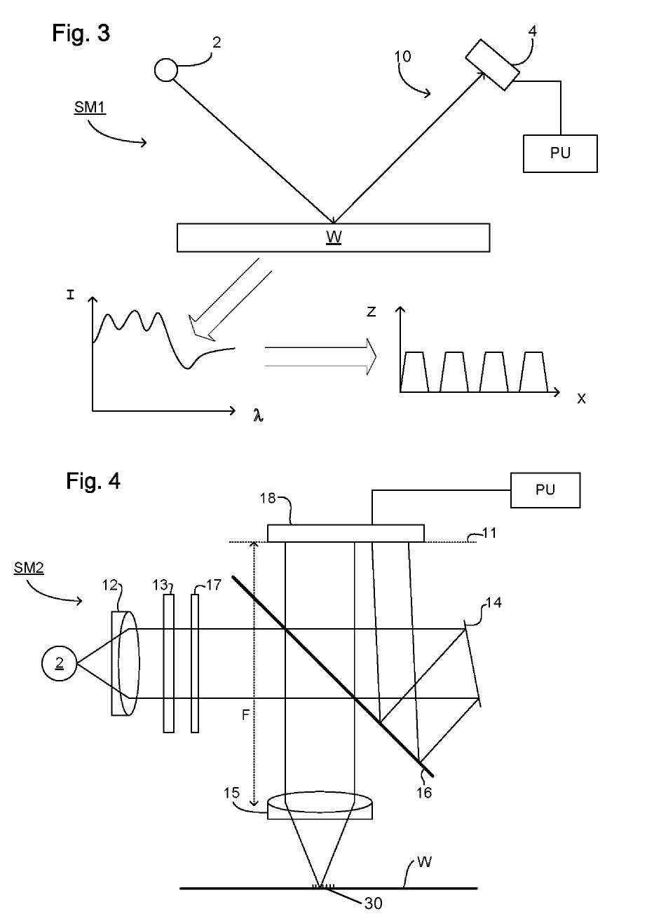

FIG. 3 depicts a scatterometer which may be used in the present invention. It comprises a broadband (white light) radiation projector 2 which projects radiation onto a substrate W. The reflected radiation is passed to a spectrometer detector 4, which measures a spectrum 10 (intensity, I, as a function of wavelength, λ) of the specular reflected radiation. From this data, the structure or profile giving rise to the detected spectrum may be reconstructed by processing unit PU, e.g., by Rigorous Coupled Wave Analysis and non-linear regression or by comparison with a library of simulated spectra as shown at the bottom of FIG. 3. In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer that may be used with the present invention is shown in

FIG. 4. In this device, the radiation emitted by radiation source 2 is focused using lens system 12 through interference filter 13 and polarizer 17, reflected by partially reflected surface 16 and is focused onto substrate W via a microscope objective lens 15, which has a high numerical aperture (NA), preferably at least 0.9 and more preferably at least 0.95. Immersion scatterometers may even have lenses with numerical apertures over 1. The reflected radiation then transmits through partially reflective surface 16 into a detector 18 in order to have the scatter spectrum detected. The detector may be located in the back-projected pupil plane 11, which is at the focal length of the lens system 15, however the pupil plane may instead be re-imaged with auxiliary optics (not shown) onto the detector. The pupil plane is the plane in which the radial position of radiation defines the angle of incidence and the angular position defines azimuth angle of the radiation. The detector is preferably a two-dimensional detector so that a two-dimensional angular scatter spectrum of a substrate target 30 can be measured. The detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16 part of it is transmitted through the beam splitter as a reference beam towards a reference mirror 14. The reference beam is then projected onto a different part of the same detector 18.

A set of interference filters 13 is available to select a wavelength of interest in the range of, say, 405-790 nm or even lower, such as 200-300 nm. The interference filter may be tunable rather than comprising a set of different filters. A grating could be used instead of interference filters.

The detector 18 may measure the intensity of scattered light at a single wavelength (or narrow wavelength range), the intensity separately at multiple wavelengths or integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e., one with a wide range of light frequencies or wavelengths—and therefore of colors) is possible, which gives a large etendue, allowing the mixing of multiple wavelengths. The plurality of wavelengths in the broadband preferably each has a bandwidth of 48 and a spacing of at least 248 (i.e., twice the bandwidth). Several “sources” of radiation can be different portions of an extended radiation source which have been split using fiber bundles. In this way, angle resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP1,628,164A, which is incorporated by reference herein in its entirety.

The marker 30 on substrate W may be a grating, which is printed such that after development, the bars are formed of solid resist lines. The bars may alternatively be etched into the substrate. This pattern is sensitive to chromatic aberrations in the lithographic projection apparatus, particularly the projection system PL, and illumination symmetry and the presence of such aberrations will manifest themselves in a variation in the printed grating. Accordingly, the scatterometry data of the printed gratings is used to reconstruct the gratings. The parameters of the grating, such as line widths and shapes, may be input to the reconstruction process, performed by processing unit PU, from knowledge of the printing step and/or other scatterometry processes.

Embodiments of the present invention relate to of a pattern for use on a mask in an exposure apparatus. The mask of the exposure apparatus may be a transmissive mask, or it may be a reflective mask such as a plurality of individually controllable elements such as mirrors. This mask is used by the exposure apparatus (in the lithographic apparatus) to print a marker on a substrate. The marker (or printed pattern) on the substrate may then be measured using an inspection apparatus such as a scatterometer or an ellipsometer. Any sort of inspection apparatus may be used including an inspection apparatus that is capable of measuring radiation that is reflected from a printed structure such as a grating and that may measure parameters of the pattern such as critical dimension (CD) of individual structures within the printed pattern; or sidewall angle (SWA) of the same structures. Other suitable inspection apparatus includes Scanning Electron Microscopes (SEM) in which an electron beam is scanned over the marker and resulting secondary electrons are detected and Atomic Force Microscopes (AFM).

The properties of the reflected radiation or the measurements of the marker on the substrate are compared with mathematical models or libraries of previous measurements or simulations and extrapolations of the relationship between these properties (of the reflected radiation or CD or SWA) and exposure-related properties of the exposure apparatus used to print the marker. The exposure-related properties may be focus offset (which may be caused by misalignment of lenses, for instance) or dose offset (caused by fluctuations in the intensity of the radiation beam, for instance). They may also be other exposure-related parameters like astigmatism, contrast or lens aberrations (typically expressed in zernikes). Alternatively, they may be illumination (i.e., radiation) parameters such as dose or intensity variation. Yet alternatively, the measured properties may be parameters that have an impact on the resist that is similar to the impact caused by dose, such as local bakeplate temperature (which gives rise to similar variations over a substrate surface in reflected radiation or CD or SWA as variations in dose over the substrate surface do) and resist variation (again, variation in resist thickness or density, etc., will give rise to variations in CD and SWA, etc., in a similar way to variations in dose).

An example of a situation in which only offsets in dose (and not necessarily focus) can be measured is as follows. A substrate, once it has been exposed, may be put on a bakeplate, which is a heated plate that dries the resist layer that is on the substrate in order to fix the pattern that has been exposed on it. The heat of the bakeplate on the bottom surface of the substrate has similar properties to intensity of radiation on the top surface of the substrate. If the temperature of the bakeplate is not homogeneous, the resist will not dry uniformly. Measurement of features on the resist (e.g., in a plurality of markers on the substrate) may be measured using the system described above in the same way as measurements are made of dose. Any variations in “dose” that are determined may in fact be variations in temperature of the bakeplate and the bakeplate may be adjusted accordingly to correct for the variations. Indeed, the same markers in the pattern fields of a substrate may be used first to measure dose variations that exist in the exposure tool, and then variations that exist in the bakeplate, taking the dose variations in the exposure tool into consideration for the later measurements. The markers in this case need only be dose-sensitive.

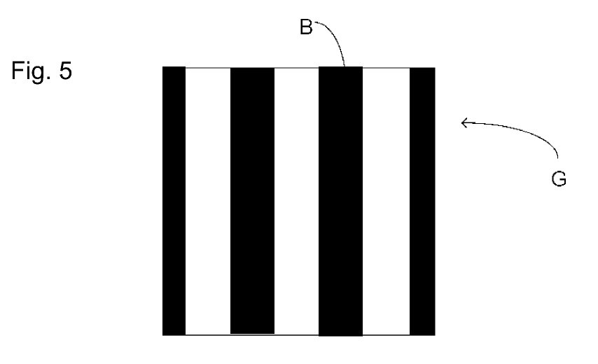

FIG. 5 shows a grating marker G that is made up of an array in one dimension of bars B (note that it is the array that is in one dimension, rather than that the bars are one-dimensional). This is the sort of pattern that is commonly used in measuring characteristics such as focus, overlay and alignment of substrates W in lithographic apparatuses. However, as mentioned above, when radiation is reflected from this grating G and parameters such as critical dimension and sidewall angle are determined from the reflected radiation.

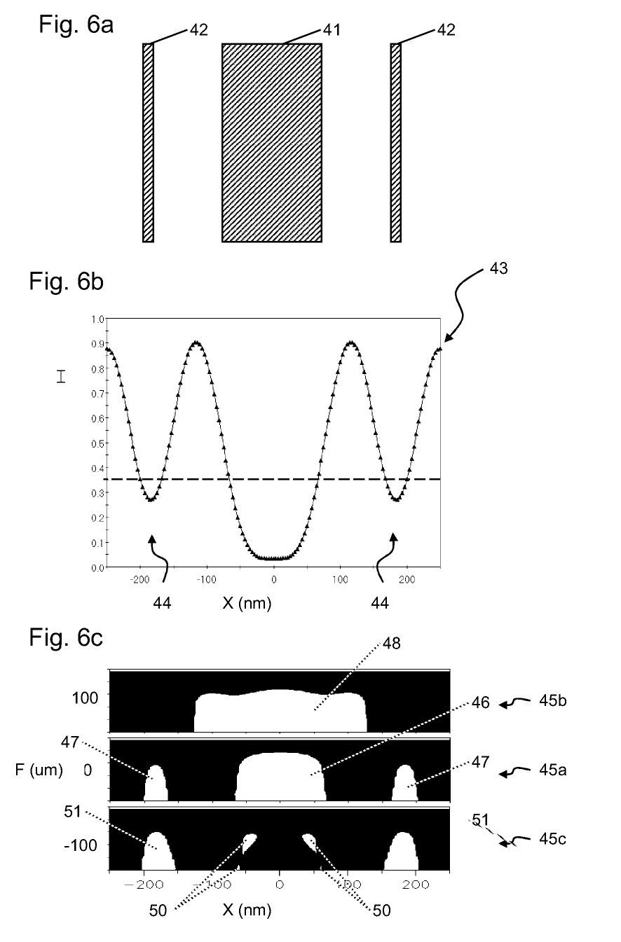

FIG. 6a depicts one embodiment of the present invention that has on the mask a marker pattern 40 with a primary bar feature 41 with secondary narrower bar features 42 located on either side of the primary bar 41. In this case the mask sizing parameters are a primary bar 41 width of about 150 nanometers a secondary bar 42 width of about 20 nanometers and a spacing between the primary bar 41 and each secondary bar 42 of about 100 nanometers. The set of bars 41, 42 are being repeated as a grating in parallel sets on a about 500 nanometer pitch. The marker pattern may be a 2-Dimensional pattern. For contact layers, 2-D markers are required to meet design rules. The bars on the mask comprise chrome that transmits about 6% of incident radiation with a transmitted phase shift of about 180 degrees. The mask is thus a about 6% attenuated Phase Shift Mask (PSM), with an attenuation factor of about 6%.

FIG. 6b depicts a graph 43 of simulated relative intensity of exposure at the resist arising from illumination of the marker pattern shown in FIG. 6a with zero focus offset. The vertical axis is relative intensity, I, and the horizontal axis is position, X, measured in nanometers. The centre of the graph around x=0 with the low intensity is the marker pattern feature corresponding to and arising from the primary bar 41 on the mask. Each of the marker side lobes 44 in this case, with a dark bar on the mask as the marker pattern, is a lobe of reduced intensity. Each side lobe 44 has therefore been augmented by further reduction in intensity at the lobe by the configuration on the mask of the respective secondary bar 42. In the inverse contrast case (not shown), with a clear slot or gap on the mask as a marker pattern, then the side lobe is a lobe of increased intensity and it is augmented by further adding to the increase in intensity at the lobe. The horizontal dotted line at a relative intensity of about 0.35 is the threshold above which exposure results in the removal of resist in the product area of the wafer. Therefore when the curve 43 drops below the threshold, resist features remain after the develop step, for example the resist features 46 and 47 in FIG. 6c.

FIG. 6c depicts a simulated resist profile of a marker structure arising from the exposure of the marker pattern shown in FIG. 6a and the intensity profile shown in FIG. 6b. The exposure conditions are a about 1.35 numerical aperture and dipole illumination. The resist profile of the marker at zero focus offset, F, is shown 45a. The primary bar 41 is printed as a primary bar marker structure feature 46. In addition, the secondary bars 42 on the mask augment the exposure side lobe arising from the primary bar feature 41 on the mask to print side lobe-induced features 47 beside the primary marker structure resist feature 46. FIG. 6b also shows simulated resist profiles with a positive focus offset 45b where the critical dimension of the primary bar 48 has increased and the side lobe secondary bars have diminished and disappeared in the out of focus condition. A simulated resist profile for a negative focus offset 45c is also shown. The primary bar feature has nearly disappeared leaving only remnants, which are washed away by the developer when not connected to the substrate. However, the side lobe components 51 of the marker have grown in critical dimension. Properties of the side lobe components may be measured, for example using scatterometry, to determine the exposure-related properties of the exposure apparatus.

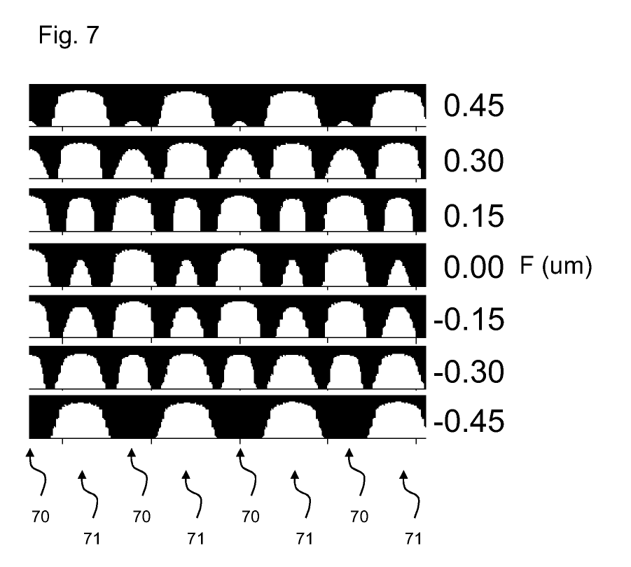

FIG. 7 depicts simulated resist profiles of a marker structure grating at a range of focus offsets from about +0.45 micron focus offset down to about −0.45 micron. The primary resist bars 70 can be seen to diminish in critical dimensions as magnitude of the focus offset increases from zero towards either about +0.45 micron or about −0.45 micron. However, the side lobe resist bars 71 have increasing critical dimensions as the magnitude of the focus offset increases.

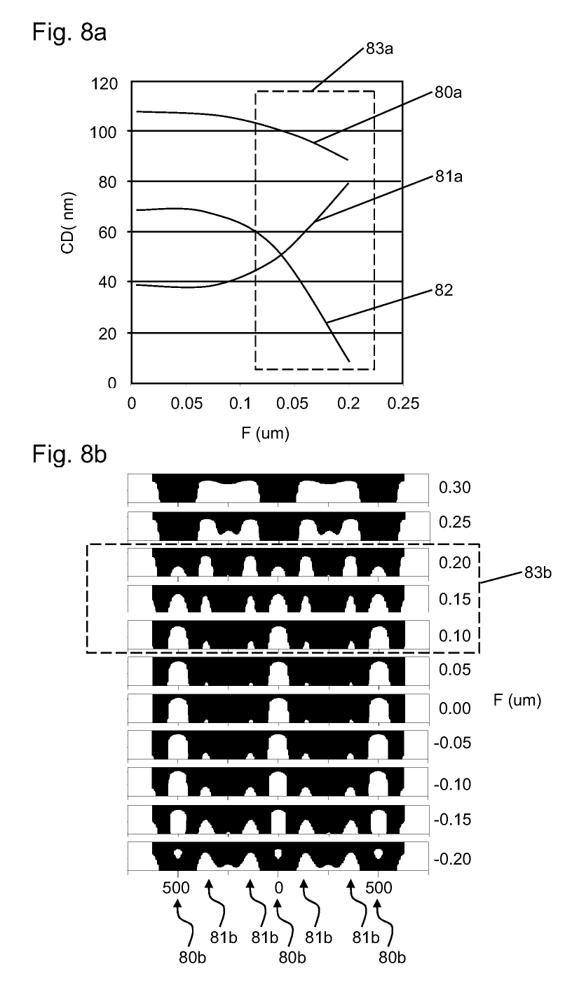

FIG. 8a depicts graphs of critical dimension (CD) in nanometers verses focus in microns on the x-axis for the primary bar features 80a and the side lobe-induced features 81a along with the difference between these two values 82. Enclosed in the dashed rectangle 83a, there is a linear region of the side lobe data 81a, which spans approximately 100 nanometers of focus offset. In this region, the slope of 81a is greater than that of 80a, showing that the sensitivity or response of the critical dimension to focus of the side lobe-induced marker components is greater than that of the primary bar of the marker structure. In this embodiment, the marker pattern is a grating with about 500 nm pitch of about 80 nm bars that transmit about 50% of incident radiation. Each bar is an attenuating phase shifter that has a about 50% attenuation factor that is different from the attenuation factor used in the mask pattern of the product area of the mask. The different attenuation factor selected so as to accentuate the production of side lobe-induced features of the marker structure relative to production of side lobe-induced features of the product structure by the projecting of the product pattern. One way in which the different attenuation factor may be controlled is by adding sub-resolution chrome patterns on top of, or under, or within, the phase shift material of the marker pattern feature on the mask so that the attenuation is altered independently from the phase shift.

FIG. 8b depicts simulated resist profiles of a printed marker structure for a range of focus offsets from about −0.20 micron at the bottom up to about +0.30 micron at the top. Over the range about 0.00 to about 0.20 this corresponds to the data shown in FIG. 8a. The primary bar structures, 80b, of the marker structure are shown flanked by the side lobe-induced structures 81b. The area 83a shown in FIG. 8a is highlighted with a corresponding dashed rectangle 83b in FIG. 8b.

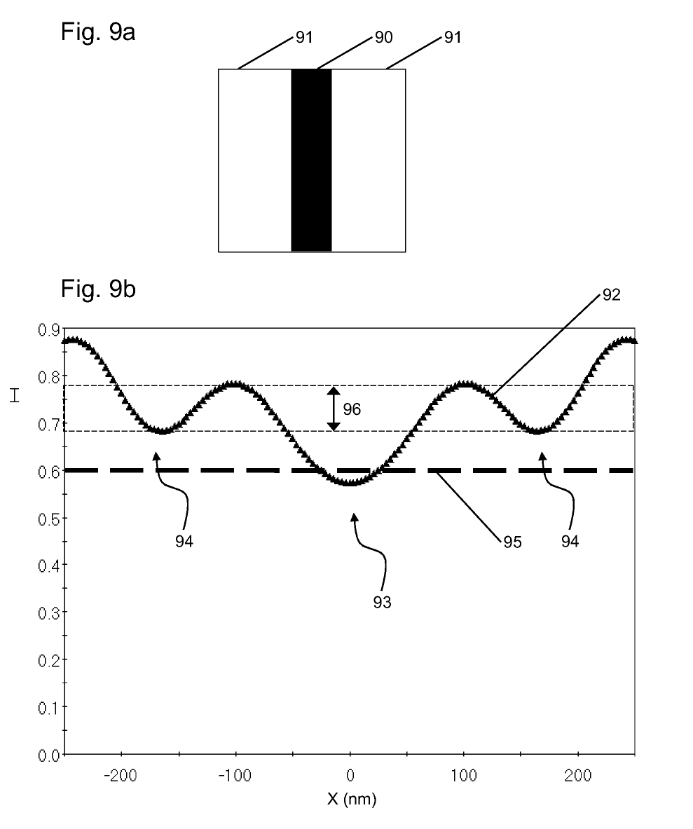

FIG. 9a depicts a marker pattern used in another embodiment of the present invention. A chrome bar 90 is placed on the mask between clear areas 91. In this embodiment, there is no secondary mask structure or different marker attenuation factor to augment the exposure side lobes. As described below, in order print the side lobes, an exposure dose is used to print the marker structure that is below the dose used to print product structures.

FIG. 9b depicts a graph 92 of simulated relative intensity of exposure at the resist arising from illumination of the marker pattern shown in FIG. 9a. The vertical axis is relative intensity and the horizontal axis is position measured in nanometers. The centre of the graph 93 around x=0 is the low intensity portion arising from the bar 90 on the mask. Each of the marker side lobes 94 in this case, with a dark bar on the mask as the marker pattern, is a lobe of reduced intensity. In this case without augmentation of the marker side lobes (such as described in relation to FIGS. 6a to 6c), at the normal level of exposure for product, each side lobe 94 is above the threshold 95 for resist removal, therefore the side lobes features of the marker structure are not printed. In this embodiment, the side lobe features of the marker are printed by reducing the exposure dose of the marker during projection of the marker pattern by the exposure apparatus in order to lower the relative intensity so that the region 96 straddles the threshold 95. This results in printing of both the primary bar structure and the side lobe-induced features of the marker structure because the marker side lobes are accentuated (their intensity is lower) relative to product side lobes for a given focus condition. The marker dose may be reduced with respect to the product dose by using an optical element attenuating the exposure on the mask, on the wafer or disposed in between them to affect the marker exposure but not the product exposure.

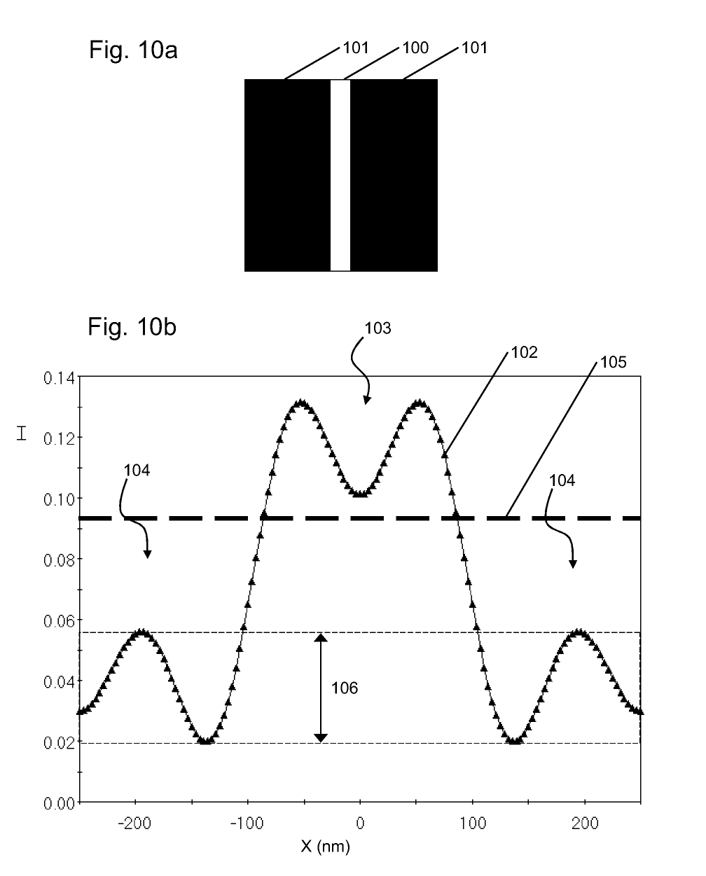

FIG. 10a depicts a marker pattern used in another embodiment of the present invention. A clear gap or slit 100 is placed on the mask in chrome areas 101. In this embodiment, there is no secondary mask feature, such as narrow gaps on either side of the bar 100, to augment the marker side lobes. As described below, in order print the side lobes, a marker dose is used to print the marker structures that is above the dose used to print product structures.

FIG. 10b depicts a graph 102 of simulated relative intensity of exposure at the resist arising from illumination of the marker pattern shown in FIG. 10a. As for FIG. 9b the vertical axis is relative intensity and the horizontal axis is position measured in nanometers. The centre of the graph 103 around x=0 is the high intensity portion arising from the slit 100 on the mask. Each of the marker side lobes 104 in this case, with a clear slot or gap on the mask as a marker pattern, is a lobe of increased intensity. Without augmentation of the marker side lobes, at the normal level of exposure for product, each side lobe 104 is below the threshold 105 for resist removal, therefore the side lobe-induced features of the mark structure are not printed. In this embodiment, the side lobe features of the marker structure are printed by increasing the exposure of the marker in order to increase the relative intensity so that the region 106 straddles the threshold 105. This results in clearing of resist at positions corresponding to 103 and 104 thus printing both the primary bar feature and the side lobe-induced features of the marker structure.

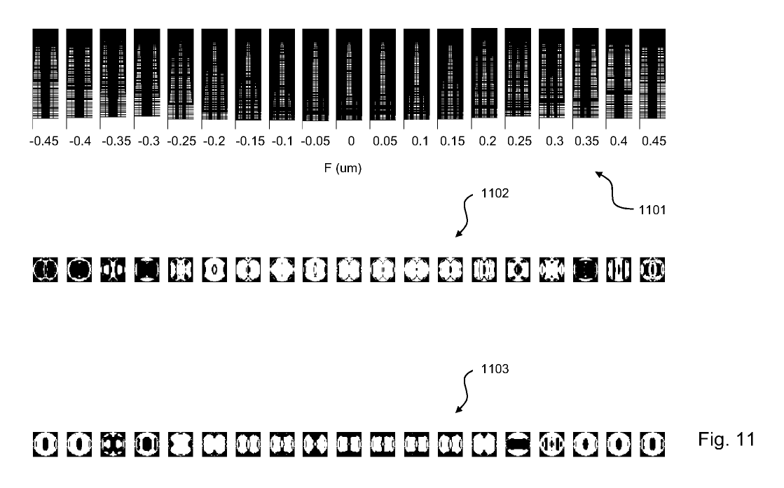

FIG. 11 depicts simulated resist profiles 1101 of a printed marker pattern according to the present invention. The resist profiles 1101 are shown with exaggerated height on the vertical axis, for focus offsets from about −0.45 through to about +0.45 micron in about 0.05 micron steps. The resist profile shows, for example in the about 0.2 micron resist profile, a central resist feature and a pair of side lobe-induced secondary structures on either side. The corresponding transverse magnetic 1102 and transverse electric 1103 scatterometry pupil plane images are also shown. This demonstrates that through the production of side lobe-induced features of the marker, not only is the form of the marker structure very responsive to focus variation, but also the scatterometry results are very responsive to focus variation.

Embodiments of the present invention use side lobe printing with an attenuated PSM focus monitoring mark for focus measurements. This takes advantage of the observation that side lobe lines widen out of focus whereas the main line shrinks out of focus.

Two options to extract focus are: 1: Use CD metrology (SEM, scatterometry, AFM. etc) to determine the width of side lobes and lines and 2: Use scatterometry then use principle component analysis (PCA) or partial least square analysis (PLS) and or related techniques on raw spectra or pupils (of angular resolved scatterometry) to extract dose and focus data.

The benefits with respect to known markers and methods include: the huge change in scatterometry pupils through focus; the linear behavior of printed side lobe structures over large focus range; the fact that the behavior of side lobes differs for positive and negative focus offset; and using conventional marks and scatterometry methods, side wall angle accuracy scales with about (1/resist height)2. This limits the extension of the use of scatterometry to thin resist. The present invention enables accurate scatterometry with thin resist.

Thus embodiments of the present invention provides more sensitive and accurate exposure-related property measurements. In particular, when used in combination with principle component analysis or equivalent methods it is faster than profile reconstruction based methods.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A method of measuring an exposure-related property of an exposure apparatus used for producing a product structure on a substrate by projecting a product pattern from a patterning device onto the substrate, the method comprising:
producing a marker structure on a substrate using the exposure apparatus that is configured to be measured by projecting a marker pattern from a patterning device onto the substrate with a marker dose of radiation; and
measuring a property of the marker structure to determine the exposure-related property of the exposure apparatus,
wherein, for the production of the marker structure, the projecting the marker pattern is modified so as to accentuate the production of side lobe-induced features of the marker structure relative to production of side lobe-induced features of the product structure by the projecting of the product pattern.

2. The method of claim 1, wherein the projecting the marker pattern is modified by providing marker pattern that comprises:
a first marker pattern feature configured to produce a marker structure feature on the substrate; and
a second marker pattern feature configured to augment a marker side lobe arising from the first marker pattern feature to produce a side lobe-induced feature on the substrate beside the marker structure feature.

3. The method of claim 2, wherein the first marker pattern feature comprises a first bar and the second marker pattern feature comprises a pair of second bars arranged on the patterning device on either side of and parallel to the first bar.

4. The method of claim 1, wherein the projecting the marker pattern is modified by providing the patterning device with a marker attenuating phase shifter having a different attenuation factor with respect to a product attenuating phase shifter in the patterning device used to produce the product structure.

5. A patterning device for use in an exposure apparatus, the patterning device including a marker pattern for producing a marker structure on a substrate using the exposure apparatus by projecting the marker pattern from the patterning device onto the substrate, the marker pattern comprising:
a first marker pattern feature configured to produce a marker structure feature on the substrate; and
a second marker pattern feature configured to augment a marker side lobe arising from the first marker pattern feature to produce a side lobe-induced feature on the substrate beside the marker structure feature.

6. The patterning device of claim 5, wherein the first marker pattern feature comprises a first bar and the second marker pattern feature comprises a pair of second bars arranged on the patterning device on either side of and parallel to the first bar.

7. The patterning device of claim 5, wherein the marker pattern comprises an array in which the first and second marker pattern features are repeated.

8. A patterning device for use in an exposure apparatus, the patterning device comprising:
a marker pattern for producing a marker structure on a substrate using the exposure apparatus by projecting the marker pattern from the patterning device onto the substrate, the marker pattern comprising a marker attenuating phase shifter; and
a product pattern configured to produce a product structure on a substrate using the exposure apparatus by projecting the product pattern from the patterning device onto the substrate, the product pattern comprising a product attenuating phase shifter,
wherein the marker attenuating phase shifter has a different attenuation factor with respect to the product attenuating phase shifter, the different attenuation factor selected so as to accentuate the production of side lobe-induced features of the marker structure relative to production of side lobe-induced features of the product structure by the projecting of the product pattern.

9. The patterning device according to claim 8, wherein the marker attenuating phase shifter comprises a sub-resolution opaque feature arranged with a phase shift material to control the attenuation factor.

10-12. (canceled)

13. The method of claim 1, wherein the projecting the marker pattern is modified by providing the marker dose to be different from a product dose used in projecting the product pattern for the production of the product structure.

14. The method of claim 1, wherein the exposure-related property of the exposure apparatus being measured comprises a focus offset of an exposure radiation beam used in projecting the marker pattern.

15. The method of any of claim 1, wherein the exposure-related property of the exposure apparatus being measured comprises a dose offset of an exposure radiation beam used in projecting the marker pattern.

16-18. (canceled)

19. An exposure apparatus for producing a product structure and a marker structure on a substrate, comprising:
a projection device configured to project a product pattern from a patterning device onto the substrate with a product dose of radiation for production of the product structure, and to project a marker pattern from a patterning device onto the substrate with a marker dose of radiation for production of the marker structure,
wherein the exposure apparatus provides a marker dose different from the product dose, the different dose factor selected so as to accentuate the production of side lobe-induced features of the marker structure by the projection of the market pattern relative to production of side lobe-induced features of the product structure by the projection of the product pattern
